(19) United States
(12) Patent Application Publication
(10) Pub. No.: US 2022/0227583 A1
(43) Pub. Date: Jul. 21, 2022

(54) Device and Method for Commissioning Pallets with Beverage Packages

(71) Applicant: Krones AG, Neutraubling (DE)

(72) Inventors: Wolfgang HUBER, Grafing (DE); Stefan POESCHL, Sinzing (DE); Thomas HOLLNBERGER, Rettenbach (DE)

(21) Appl. No.: 17/615,677

(22) PCT Filed: May 28, 2020
(86) PCT No.: PCT/EP2020/064805

§ 371 Date: Dec. 1, 2021

(30) Foreign Application Priority Data
Jun. 7, 2019 (DE) 102019208324.2

(51) Int. Cl. B65G 1/137

(52) U.S. Cl. CPC B65G 1/1378; B65G 2201/0244

(57) ABSTRACT

The invention relates to a device and a method for picking pallets (17) having beverage containers (9, 10), comprising a device for providing empty pallets, at least two production lines (1, 2), each comprising packers (7, 8) for providing beverage containers (9, 10), a high-bay warehouse (13) for receiving and storing beverage containers (9, 10) and special containers (15), a separate transport device (21), which is designed to transport special containers (15) to the high-bay warehouse (13) and to store them there, transport devices (11, 12), each leading from the production lines (1, 2) to the high-bay warehouse (13) and being designed to transport the beverage containers (9, 10) to the high-bay warehouse (13) and to store them there. The device for picking furthermore comprises one or more palletizers (16), each being designed to move beverage containers (9, 10) and/or special containers (15) provided from the high-bay warehouse (13) to a pallet (17-19).

### RELATED APPLICATIONS

This application claims the benefit of International Application No. PCT/EP2020/064805, filed May 28, 2020, which claims priority to German Application No. DE102019208324.2, filed Jun. 7, 2019. The entire contents of both applications are hereby incorporated by reference.

### TECHNICAL FIELD

The present invention relates commissioning pallets with beverage packages.

### BACKGROUND

EP 2 874 926 B1 discloses a method and a device for loading a pallet with different types of individual packages. The individual packages to be palletized are delivered, stored in a provisioning storage with several planes/storage shelves arranged one above the other and one next to the other, and made available such that a palletizing device has access to all the individual packages. The individual packages are then picked up in a sequence specified by the palletizer and stacked on a pallet.

EP 0 897 880 B1 discloses a method for commissioning and packing and/or distributing articles, wherein the respective means of transport or packing selected by the control system is allocated to the commissioned articles by means of an electronic control system. Commissioning areas can be provided for different types of articles in each case, in which the articles are stored and commissioned. The articles are brought together with the transport or packing means and placed in or on the latter. The transport or packing means may be temporarily stored, at least partially, in a buffer store before being brought together. Transport devices of the articles and transport devices of the transport or packing means cross each other at at least one transfer point.

In addition, it is known that in large container treatment plants, on the one hand, long times are required for cooling the packages after a shrink tunnel. Long conveyor belts are currently provided for this purpose. In addition, more and more commissioning systems are installed in order to re-sort goods previously palletized by type, for example beverage containers, onto so-called mixed pallets. The effort involved is considerable in terms of space and also logistics.

### SUMMARY

An object of aspects of the present invention is to provide a device or system and method for commissioning pallets with beverage packages that reduce the effort of intermediate storage, depalletizing and re-palletizing.

This problem is solved according to embodiments of the present invention by a device or system for commissioning pallets with beverage packages and a method for commissioning pallets with beverage packages as set forth below.

A device for commissioning pallets with beverage packages comprises a device for providing empty pallets, at least two production lines, each comprising packers for providing beverage packages, a shelf warehouse for receiving and storing beverage packages and special packages, a separate transport device, which is adapted to transport special packages to the shelf warehouse and to store them there, transport devices, which each lead from the production lines to the shelf warehouse and are adapted to transport the beverage packages to the shelf warehouse and to store them there. Furthermore, the device for commissioning pallets comprises one or more palletizers, each of which is adapted to transfer beverage packages and/or special packages provided by the shelf warehouse onto a pallet.

For example, a first production line may provide a first product in a first type of container and a second production line may provide a second product in a second type of container. The first product and/or the first type of container may be different from the second product and/or the second type of container. Thus, the one shelf warehouse can store different packages and, based on the one shelf warehouse, pallets can be loaded with different or the same beverage packages.

The beverage packages and/or special packages can be stored in the shelf warehouse for a longer period of time, for example hours, days, a week or longer, so that even if a beverage is not produced, corresponding beverage packages and/or special packages of this beverage can be retrieved.

The shelf warehouse can be configured for cooling the beverage packages and/or special packages. Beverage packages and/or special packages which, after leaving a shrink tunnel, in which the containers are at least partially combined by means of shrink film to form the beverage packages and/or the special packages, can cool down again in the shelf warehouse. Therefore, long conveyor belts on which the beverage packages and/or special packages cool during transport can be dispensed with.

Special packages can be packages that are not produced at a location of the device for commissioning pallets with beverage packages. Such special packages can be fed to the shelf warehouse via a separate input/output. However, special packages can also be understood as containers that are produced rarely, for example with one of the production lines of the device for commissioning pallets with beverage packages and, for example, with only 10% or less compared to the total production.

The device can also comprise one or more transport devices which transport beverage packages from the at least two production lines directly to one or more palletizers, i.e. without storing the beverage packages in the shelf warehouse. Thus, even without storage, pallets of the same type can be prepared, i.e., pallets loaded with the same beverage packages.

The device can further comprise a control device with which the beverage packages to be commissioned and the pallet can be settable and with which the device can be controlled. The control device can be used to set which and how many beverage packages are to be loaded onto which pallet.

A method for commissioning pallets with beverage packages using the device or system as described above or further below comprises the following steps:
providing empty pallets,
providing beverage packages by means of respective packers from at least two production lines
transporting special packages to a shelf warehouse by means of a separate transport device and storing the special packages in the shelf warehouse,
transporting the beverage packages to the shelf warehouse by means of transport devices which each lead from the production lines to the shelf warehouse and storing the beverage packages in the shelf warehouse, and
providing, by the shelf warehouse, beverage packages and/or special packages for one or more palletizers and transferring the beverage packages and/or special packages to a pallet by means of the palletizers.

For example, the separate transport device is not part of the production lines.

The method can further comprise a step of cooling the beverage packages and/or special packages in the shelf warehouse. Thus, beverage packages and/or special packages can cool down again after leaving a shrink tunnel in which containers are at least partially combined by means of shrink film to form the beverage packages and/or special packages. Therefore, long conveyor belts on which the beverage packages and/or special packages cool during transport can be dispensed with.

The method can further comprise a step of setting the beverage packages and/or special packages to be commissioned and the pallet, and a step of controlling the device by means of the control device. This can be used to set which and how many beverage packages and/or special packages are to be moved onto which pallet.

### BRIEF DESCRIPTION OF THE DRAWINGS

The accompanying Figures exemplify aspects and embodiments of the invention for better understanding and illustration. Therein:

FIG. 1 shows a schematic view of a device or system for commissioning pallets with beverage packages; and

FIG. 2 shows a flow diagram of a method for commissioning pallets with beverage packages.

### DETAILED DESCRIPTION

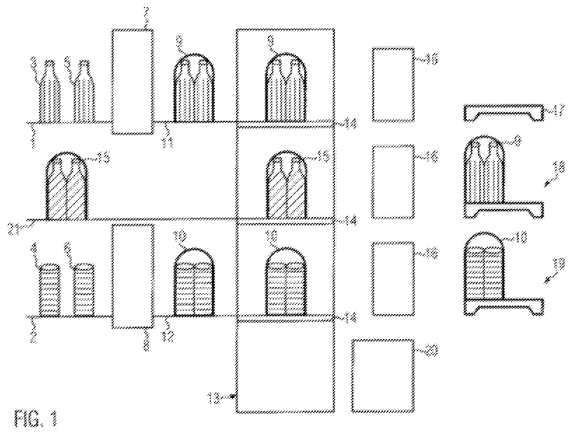

FIG. 1 shows a schematic view of a device or system for commissioning pallets 17 with beverage packages 9, 10. Exemplarily, two production lines 1, 2 are shown which provide a first product 3 in a first type of container 5 and a second product 4 in a second type of container 6. The first product 3 and/or the first type of container 5 may be different from the second product 4 and/or the second type of container 6.

Each of the two production lines 1, 2 comprises a packer 7, 8, which prepares packages 9, 10 from the individual containers 5, 6. In this process, six containers can be at least partially combined by means of shrink film to form a beverage packages; another number of containers can also be combined to form beverage packages.

The beverage packages 9, 10 are transported from the packers 7, 8 by means of transport devices 11, 12, which lead from the packers 7, 8 to a shelf warehouse 13, to the shelf warehouse 13 and stored there. Exemplarily, the shelf warehouse 13 is shown equipped with three shelves 14. Instead of the shelves 14, however, drawers and/or tubs can also be provided for storing the beverage packages 9, 10 and/or also special packages 15.

Exemplarily, it is shown that special packages 15 are fed to the shelf warehouse 13 by means of a separate transport device 21. The beverage packages 9, 10 and/or special packages 15 stored in the shelf warehouse 13 can be made available to the palletizers 16, here three palletizers 16 are shown as an example, in order to transfer beverage packages 9, 10 and/or special packages 15 to a pallet 17. In FIG. 1, moving the beverage packages 9, 10 onto pallets 17 results in partially loaded pallets 18, 19. A fully loaded pallet may comprise one or more layers of beverage packages and/or special packages or mixtures thereof.

By means of a control device 20, the beverage packages 9, 10 and/or special packages to be commissioned and a pallet 17 to be loaded can be set, for example, which and how many beverage packages 9, 10 and/or special packages 15 are to be moved onto which pallet 17. The control device 20 may be adapted to control the device for commissioning pallets.

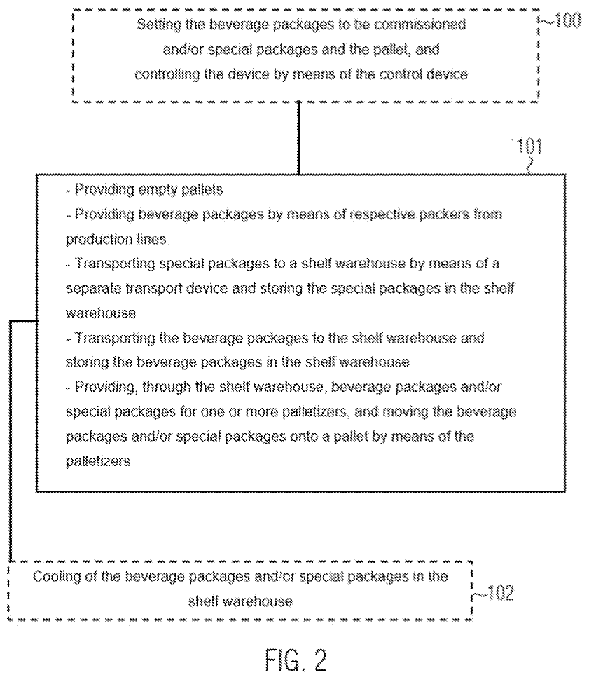

FIG. 2 shows a flow diagram of a method for commissioning pallets with beverage packages using the device or system as described above.

In step 100, optionally the beverage packages to be commissioned and the pallet can be set and the device or system can be controlled by means of the control device.

In step 101, the following takes place: providing empty pallets, providing beverage packages by means of respective packers from at least two production lines, transporting special packages to a shelf warehouse by means of a separate transport device and storing the special packages in the shelf warehouse, transporting the beverage packages to the shelf warehouse by means of transport devices, each leading from the packers to the shelf warehouse and storage of the beverage packages in the shelf warehouse, providing, by the shelf warehouse, beverage packages and/or special packages for one or more palletizers, and transferring the beverage packages and/or special packages to a pallet by means of the palletizers.

While the beverage packages are stored in the shelf warehouse, optional cooling of the beverage packages and/or special packages in the shelf warehouse can take place in step 102.

1. A system for commissioning pallets with beverage packages, the system comprising:
a device for providing an empty pallet;
at least two production lines each comprising a packer for providing beverage packages;
a shelf warehouse for receiving and storing the beverage packages and special packages;
a separate transport device adapted to transport the special packages to the shelf warehouse for storage;
transport devices which each lead from a respective one of the production lines to the shelf warehouse and which are adapted to transport the beverage packages to the shelf warehouse for storage; and
one or more palletizers, each of which is adapted to transfer, onto the empty pallet, at least one of beverage packages or special packages provided by the shelf storage.

2. The system according to claim 1, wherein the shelf warehouse is adapted for cooling at least one of the beverage packages or the special packages.

3. The system according to claim 1, further comprising one or more additional transport devices, which transport the beverage packages of the at least two production lines directly to the one or more palletizers.

4. The system according to claim 1, further comprising a control device adapted to set the beverage packages and to control the system.

5. A method of commissioning pallets with beverage packages, the method comprising:
providing an empty pallet;
providing beverage packages using respective packers from at least two production lines of a system;
transporting special packages to a shelf warehouse of the system using a separate transport device of the system and storing the special packages in the shelf warehouse;
transporting the beverage packages to the shelf warehouse using transport devices of the system that each lead from a respective one of the packers to the shelf warehouses;
storing the beverage packages in the shelf warehouse; and
providing, through the shelf warehouse, at least one of the beverage packages or the special packages for one or more palletizers of the system; and
moving at least one of the beverage packages or the special packages onto the empty pallet using the one or more palletizers

6. The method according to claim 5, further comprising:
cooling at least one of the beverage packages or the special packages in the shelf warehouse.

7. The method according to claim 5, further comprising:
setting at least one of the beverage packages or the special packages and the pallet; and
controlling the system using a control device.

8. The method according to claim 5, further comprising:
transporting the beverage packages of the at least two production lines directly to the one or more palletizers using one or more additional transport devices.
